(19) United States
(12) Patent Application Publication
(10) Pub. No.: US 2014/0317954 A1
(43) Pub. Date: Oct. 30, 2014

(54) METHOD AND APPARATUS FOR AUTOMATICALLY DRYING WET FLOORS

(71) Applicant: Norgren Automation Solutions, LLC, Saline, MI (US)

(72) Inventors: Scott R. McCallum, St. Clair, MI (US); Timothy John Key, Onsted, MI (US); James R. Kalb, Petersburg, MI (US); Richard Daniel Koski, Saline, MI (US); John D. Begin, Chesterfield Township, MI (US)

(21) Appl. No.: 14/324,790

(22) Filed: Jul. 7, 2014

Related U.S. Application Data
(63) Continuation-in-part of application No. 13/891,868, filed on May 10, 2013.
(60) Provisional application No. 61/645,162, filed on May 10, 2012.

(51) Int. Cl. F26B 21/06

(52) U.S. Cl. CPC F26B 21/06
USPC 34/565; 34/89

(57) ABSTRACT

An apparatus for automatically drying wet floors includes a floor mat; a controller; a detector mat that is positioned adjacent to the floor mat, the detector mat having at least one moisture sensing element that is operable to detect moisture and transmit a moisture detection signal to the controller in response to detecting the presence of moisture at the first location, and a floor dryer that is operative to turn on and off for drying the floor mat by directing moving air toward the floor mat in response to an operating signal from the controller, wherein the controller outputs the operating signal to the blower based on the moisture detection signal.

### CROSS-REFERENCE TO RELATED APPLICATIONS

This application is a continuation-in-part of U.S. Non-Provisional patent application Ser. No. 13/891,868, filed on May 10, 2013, which claims the benefit of U.S. Provisional Patent Application Ser. No. 61/645,162, which was filed on May 10, 2012.

### TECHNICAL FIELD

The disclosure herein relates to a method and apparatus for automatically drying wet floors, and more particularly, a method and apparatus that automatically dries wet floors made wet by pedestrians walking into a building from outside the building during wet weather conditions.

### BACKGROUND

The problem of wet floors caused by pedestrians tracking water into buildings during rainy or snowy weather conditions has existed as long as people have inhabited buildings. Water or snow tracked onto interior floors is not only unsightly, but it can represent a safety hazard, thereby creating a liability for businesses and homeowners. Traditional techniques for dealing with wet floors include placing rugs or mats near entranceways to absorb water being tracked into a building. The disadvantages to this approach include having to replace or clean the rugs or mats on a regular basis, thereby incurring material and labor costs. In addition, water from the rugs or mats can still be tracked onto the floors beyond the placement of the rugs or mats, as pedestrians walk onto the wet rugs or mats and track the water onto the floor of the building.

Another technique for drying floors includes manually positioning fans or blowers to dry the floor of a building when it is observed that the floor is wet. The disadvantage of this approach is that it requires labor to observe the wet floor and manually move the fans or blowers into position while also removing the fans or blowers when the floor is dry.

### SUMMARY

Methods and apparatuses for automatically drying wet floors are disclosed herein.

One aspect of the disclosed embodiments is an apparatus for automatically drying wet floors that includes a floor mat; a controller; a detector mat that is positioned adjacent to the floor mat, the detector mat having at least one moisture sensing element that is operable to detect moisture and transmit a moisture detection signal to the controller in response to detecting the presence of moisture at the first location, and a floor dryer that is operative to turn on and off for drying the floor mat by directing moving air toward the floor mat in response to an operating signal from the controller, wherein the controller outputs the operating signal to the blower based on the moisture detection signal.

Another aspect of the disclosed embodiments is an apparatus for automatically drying wet floors that includes a floor mat having a backing layer and a carpet layer that is disposed on the backing layer; a controller; a detector mat that is positioned adjacent to the floor mat, the detector mat having at least one moisture sensing element that is operable to detect moisture and transmit a moisture detection signal to the controller in response to detecting the presence of moisture at the first location, wherein the detector mat includes a body that is liquid impervious, the at least one moisture sensing element includes a plurality of electrodes that are disposed on the body, the body of the detector mat includes a plurality of channels that are recessed with respect to a top surface of the detector mat, and at least some of the electrodes are positioned along the channels; and a floor dryer that is operative to turn on and off for drying the floor mat by directing moving air toward the floor mat in response to an operating signal from the controller, wherein the controller outputs the operating signal to the blower based on the moisture detection signal.

Another aspect of the disclosed embodiments is a detector mat for detecting moisture that includes a body that is liquid impervious and includes a plurality of channels that are recessed with respect to a top surface of the body; and at least one moisture sensing element that is operable to detect moisture and output a moisture detection signal in response to detecting the presence of moisture at the first location, wherein the at least one moisture sensing element includes a plurality of electrodes that are disposed on the body and at least some of the electrodes are positioned along the channels of the body.

Another aspect of the disclosed embodiments is an apparatus for automatically drying wet floors that includes a controller, a moisture detector, and a blower. The moisture detector is operable to detect the presence of moisture at a first location and transmit a moisture detection signal to the controller in response to detecting the presence of moisture at the first location. The blower is operative to turn on and off for drying the wet floors by directing moving air toward the first location in response to an operating signal from the controller. The controller outputs the operating signal to the blower based on the moisture detection signal.

Another aspect of the disclosed embodiments is an apparatus for automatically drying wet floors that includes a controller, a floor mat, and a blower. The floor mat includes a carpet layer that includes carpet fibers that define a carpet surface. The floor mat also includes an impermeable and non-conductive carpet backing layer that has a top surface and a bottom surface. The top surface of the covered backing layer has the carpet fibers affixed thereto. The floor mat also includes a first electrode assembly that has a first conductor portion that is disposed adjacent to the bottom surface of the carpet backing layer and a plurality of first electrodes. The first electrodes are electrically connected to the first conductor portion, extend through the carpet backing layer, and are disposed within the carpet layer. The floor mat also includes a second electrode assembly that has a second conductor portion that is disposed adjacent to the bottom surface of the carpet backing layer and a plurality of second electrodes. The second electrodes are electrically connected to the second conductor portion, extend through the carpet backing layer, and are disposed within the carpet layer. The floor mat also includes a control circuit for transmitting a moisture detection signal to the controller by wireless communication with the controller in response to a completed electrical circuit that includes electrical communication between the first electrode assembly and the second electrode assembly via a wetted portion of the carpet layer. The blower is operable to turn on and off for drying the wet floors by directing moving air toward the floor mat in response to an operating signal from the controller. The controller outputs the operating signal to the blower based on the moisture detection signal.

Another aspect of the disclosed embodiments is a method for automatically drying wet floors that includes detecting the presence of moisture by a moisture detector at a first location; transmitting a moisture detection signal from the moisture detector to a controller in response to detecting the presence of moisture at the first location; outputting an operating signal from the controller to a blower based on the moisture detection signal if an operating condition is satisfied; and operating the blower in response to the operating signal.

### BRIEF DESCRIPTION OF THE DRAWINGS

FIG. 1 is a perspective schematic diagram of a first example apparatus for automatically drying wet floors;

FIG. 2 is a perspective schematic diagram of a second example apparatus for automatically drying wet floors;

FIG. 3 is a perspective schematic diagram of a third example apparatus for automatically drying wet floors;

FIG. 4 is a perspective schematic diagram of a fourth example apparatus for automatically drying wet floors;

FIG. 5 is a top cutaway view showing a moisture detecting floor mat;

FIG. 6 is a side cross-section view of the moisture detecting floor mat;

FIG. 7 is a block diagram of an apparatus for automatically drying wet floors including the moisture detecting floor mat;

FIG. 8 is an illustration showing a fifth example apparatus for drying wet floors;

FIG. 9 is a perspective view showing a detector mat of the fifth example apparatus; and

FIG. 10 is a cross-section view of the detector mat.

### DETAILED DESCRIPTION

The description herein is directed to methods and apparatuses for automatically drying wet floors of a building. The examples herein include apparatuses that detect conditions that may give rise to water being tracked onto floors of a building or may detect the water as the water is actually being tracked onto the floors of the building. In some examples, a sensor is mounted outside of a building near an entranceway of the building for detecting conditions that may result in water being tracked into the building, such as rain, snow, and/or hail. In other examples, the water being tracked into the building may be detected by sensors inside the building, such as sensors on a rug or mat lying on the floor of the building, or a machine vision system that is operable to capture images of an area inside the building and determine if water is presented in the area. Upon detecting conditions that could cause water to be tracked onto the floor of the building, or upon detecting the tracked water on the floor of the building, signals can be sent to warning devices that alert pedestrians of a potential hazard in the vicinity of the tracked water on the floor of the building.

In some examples, when tracked water or conditions that can lead to tracked water on the floor of the building are sensed, a drying device is operated in response to the signals indicating the presence of tracked water. As examples, the drying device can be a blower or fan, which is placed into operation to begin drying the tracked water on the floor of the building. In implementations where sensors are utilized to detect the tracked water within the building, the sensors detect a change in the presence of moisture during the drying process and signal the blower, fan, or other drying device to stop operating when the tracked water has been substantially removed from the floor of the building. The sensors can include video cameras connected to controllers that visually detect tracked water using image processing techniques, or the mats with sensors can be utilized for detecting moisture. The sensors, warning devices, and drying devices can be connected to a controller that inputs data from the sensors and outputs signals to control the warning devices and the drying devices.

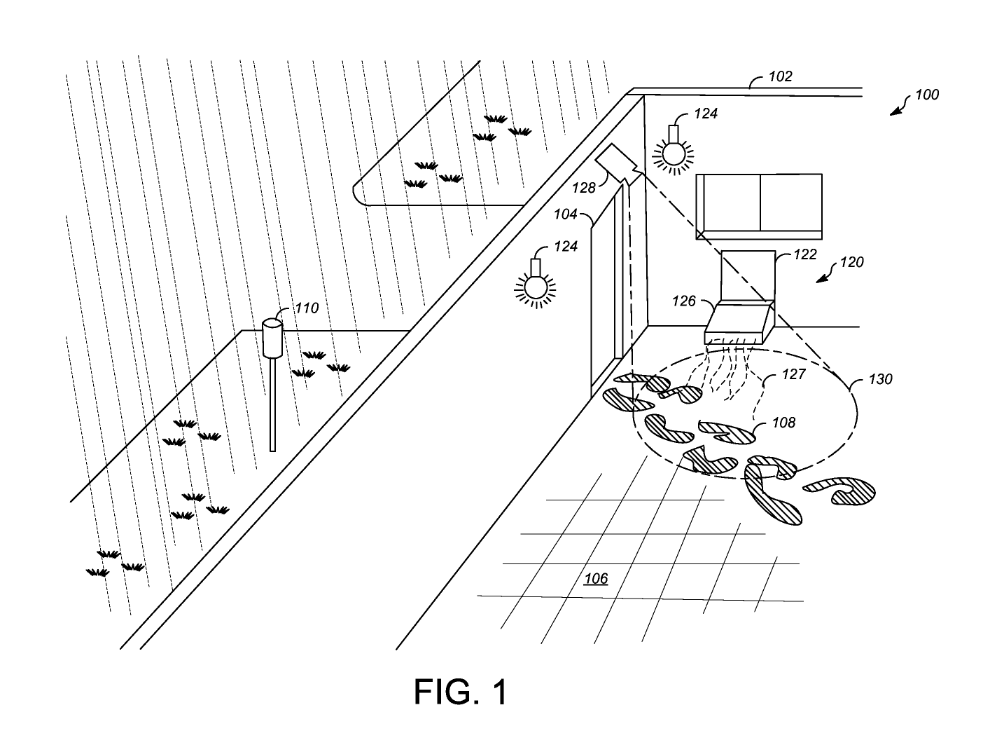

FIG. 1 shows a first example apparatus 100 for automatically drying wet floors of a building. The first example apparatus 100 is installed in a building 102 having an entranceway 104 and a floor 106. A moisture detector in the form of a wet weather sensor 110 may be installed at a location that is outside of the building 102 where the wet weather sensor 110 has access to the weather elements, such as on the roof of the building 102. The wet weather sensor 110 may be any type of sensor, including electrical or optical, that detects weather conditions that could lead to water being tracked into the building 102, including rain, snow, and/or hail, for example. The weather condition detected by the wet weather sensor 110 may be referred to herein as a sensed weather condition.

When the wet weather sensor 110 detects wet weather, the wet weather sensor 110 sends a moisture detection signal to a drying system 120. The drying system 120 may include a controller 122 that receives the moisture detection signal from the wet weather sensor 110 and makes a decision, based on hardware or software, whether to send warning control signals to warning devices 124. The warning devices 124 can be or include illuminated warning indicators such as flashing yellow lights or illuminated signs that are mounted to the inside walls of the building 102 to warn pedestrians that potential tracked water 108 may exist on the floor 106 of the building 102 thereby creating a potentially hazardous condition. The warning devices 124 can turn on and turn off in response to the warning control signals.

The controller 122 can also output an operating signal to a drying device such as an electric blower 126 that is mounted to an inner wall and/or the floor 106 of the building 102. The electric blower 126 is operable to direct rapidly moving air 127 across the floor 106 of the building 102 to begin drying the tracked water 108. The electric blower 126 may also contain a heating element (not shown) built therein so that the electric blower 126 blows warm or hot air across the floor 106 of the building 102 so as to decrease the time associated with drying the floor 106.

In order to detect the condition of the floor 106 in the building 102, a moisture detector can be provided in the form of a vision system, which may include a video camera 128. The video camera 128 can be mounted to an inner wall of the building 102 such that the video camera 128 has a field of view 130 that encompasses a first location, such as an area of the floor 106 that is likely to have tracked water 108 thereon.

The video camera 128 is connected to the controller 122. The controller 122 can be operable to process an image that is output by the video camera 128 and detect the presence of moisture within the field of view 130 of the video camera 128 based on the image that is received from the video camera 128. The video camera 128 may be utilized to determine that tracked water 108 is on the floor 106 of the building 102 as opposed to utilizing the wet weather sensor 110. If the video camera 128 is used to discover the tracked water 108 on the floor 106 of the building 102, then the video camera 128 sends the moisture detection signal to the controller to engage the drying system 120. Regardless of whether the wet weather sensor 110 or the video camera 128 is utilized to determine whether tracked water 108 is on the floor 106 of the building 102, the drying system 120 will determine whether the images acquired by the video camera 128 indicate that the tracked water 108 has been sufficiently removed by the electric blower 126. If so, the drying system 120 will signal the warning devices 124 and the electric blower 126 to stop operating.

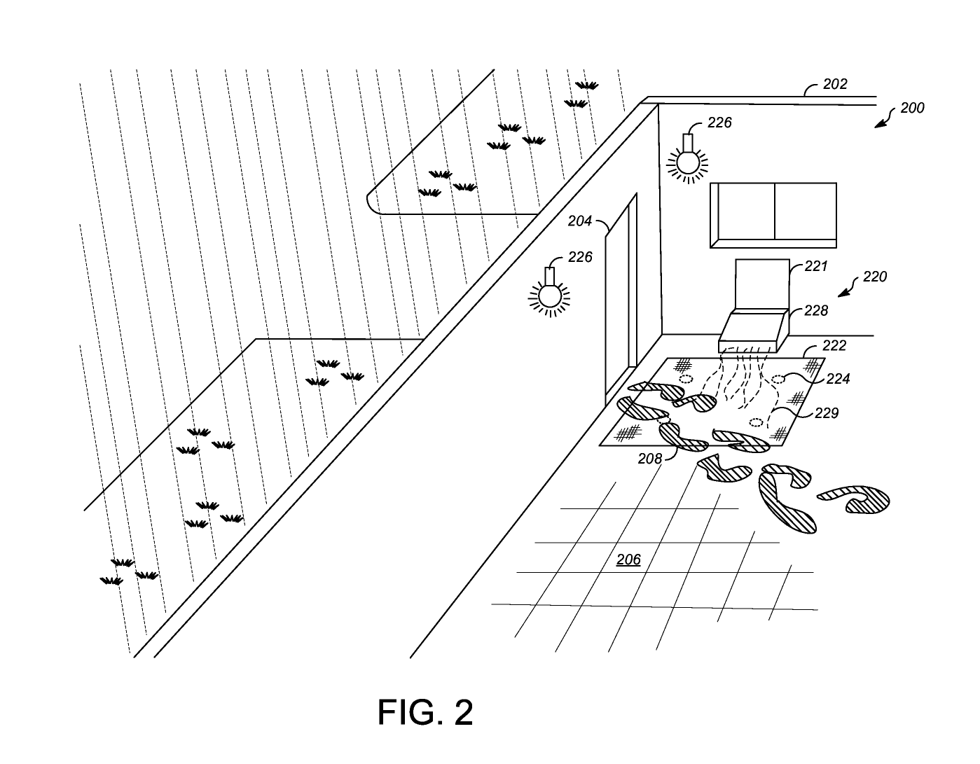

FIG. 2 shows a second example apparatus 200 in which a drying system 220 is installed in a building 202 having an entranceway 204 and a floor 206. In this embodiment, tracked water 208 is detected by one or more moisture sensors 224 that are built into a rug or a mat 222 that is positioned at a first location on the floor 206 near the entranceway 204 of the building 202. The moisture sensors 224 in the mat 222 signal the drying system 220 that moisture has been detected on the mat 222 and may lead to tracked water 208 beyond the mat 222 by transmitting a moisture detection signal from the mat 222 to a controller 221 of the drying system 220. In some implementations, the moisture detection signal can be wirelessly transmitted from the mat 222 to the controller 221, using well-known wireless communication protocols such as Wi-Fi or Bluetooth. In other implementations, a wired electrical connection can be made between the mat 222 and the controller 221. The controller 221 of the drying system 220 transmits a warning control signal to the warning devices 226 mounted on the inner walls of the building 202, similar to the warning devices 124 provided in the first example apparatus 100, to indicate possible hazardous conditions to pedestrians regarding moisture on the floor 206 of the building 202.

The drying system 220 also provides an operating signal to an electric blower 228 that is mounted on the inner wall and/or the floor 206 of the building 202, as similarly described in the first embodiment. The electric blower 228 may then begin drying the floor 206 by directing rapidly moving air 229 toward the first location, including the mat 222 and the floor 206 of the building 202. Again, the electric blower 228 may have a heating element (not shown) built therein such that the electric blower 228 may blow warm or hot air across the floor 206 of the building 202 so as to reduce the time associated with drying the floor 206. The moisture sensors 224 in the mat 222 can also detect the change in moisture resulting from the electric blower 228 drying the floor 206. When the moisture sensors 224 detect a change in the moisture thereby indicating that the floor 206 is drying, the moisture sensors 224 signal the drying system 220 to stop flashing the warning devices 226 and to stop the electric blower 228.

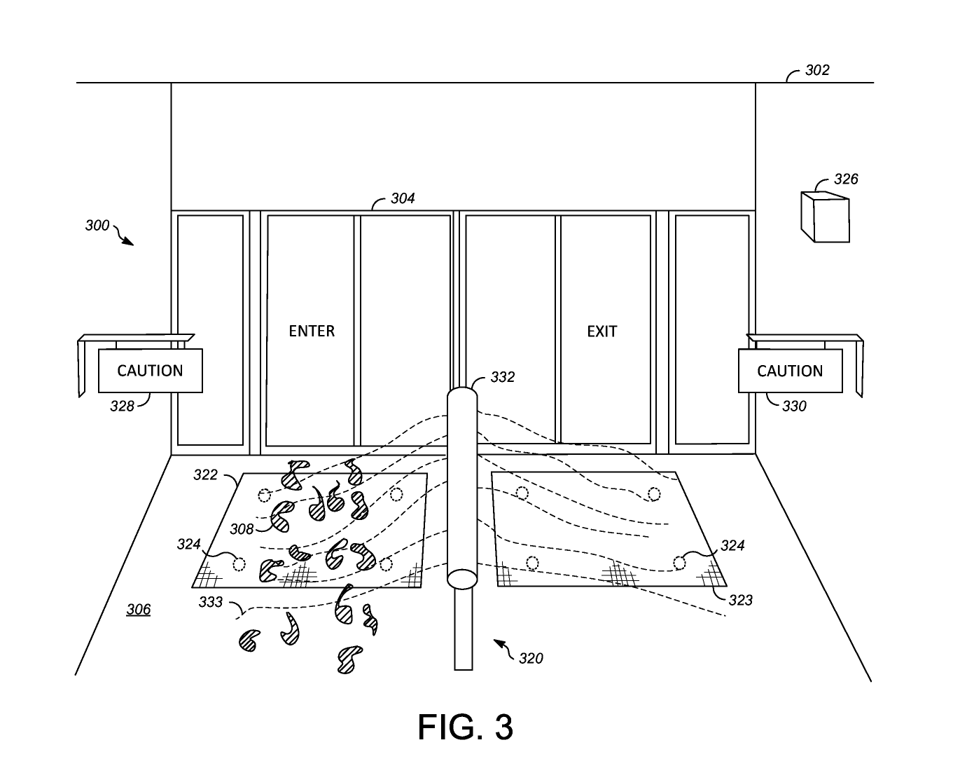

FIG. 3 shows a third example apparatus 300 in which a drying system 320 is installed in a building 302 having an entranceway 304 and a floor 306. Tracked water 308 on the floor 306 of the building 302 can be detected by at least one or more moisture sensors 324 mounted within rugs or mats 322, 323 disposed at a first location on the floor 306 of the building 302. Upon sensing moisture, the moisture sensors 324 provide a signal to a controller 326 indicating that moisture, which may lead to tracked water 308, is detected. The controller 326 may transmit a warning control signal to warning devices 328, 330, such as “caution” signs mounted to the inner walls of the building 302 to cause the warning devices 328, 330 to flash in an illuminating manner. The warning devices 328, 330 are to warn pedestrians of possible hazardous conditions caused by the tracked water 308 on the floor 306 of the building 302.

In addition, the controller 326 may transmit an operating signal to a drying device, such as an electric blower 332 to engage and begin drying the floor 306. The electric blower 332 may be mounted directly to and above the floor 306 of the building 302 adjacent to the rugs or mats 322, 323 so that the electric blower 332 may blow rapidly moving air 333 directly across the rugs or mats 322, 323. Again, the electric blower 332 may contain a heating element (not shown) built therein so that warm or hot air may be used to reduce the time associated with drying the rugs or mats 322, 323 on the floor 306 of the building 302. When the moisture sensors 324 indicate to the controller 326 that the floor 306 is sufficiently dry, the controller 326 may transmittal signals to the warning devices 328, 330 to cause the warning devices 328, 330 to stop indicating hazardous conditions and cause the electric blower 332 to disengage and stop drying the floor 306 of the building 302.

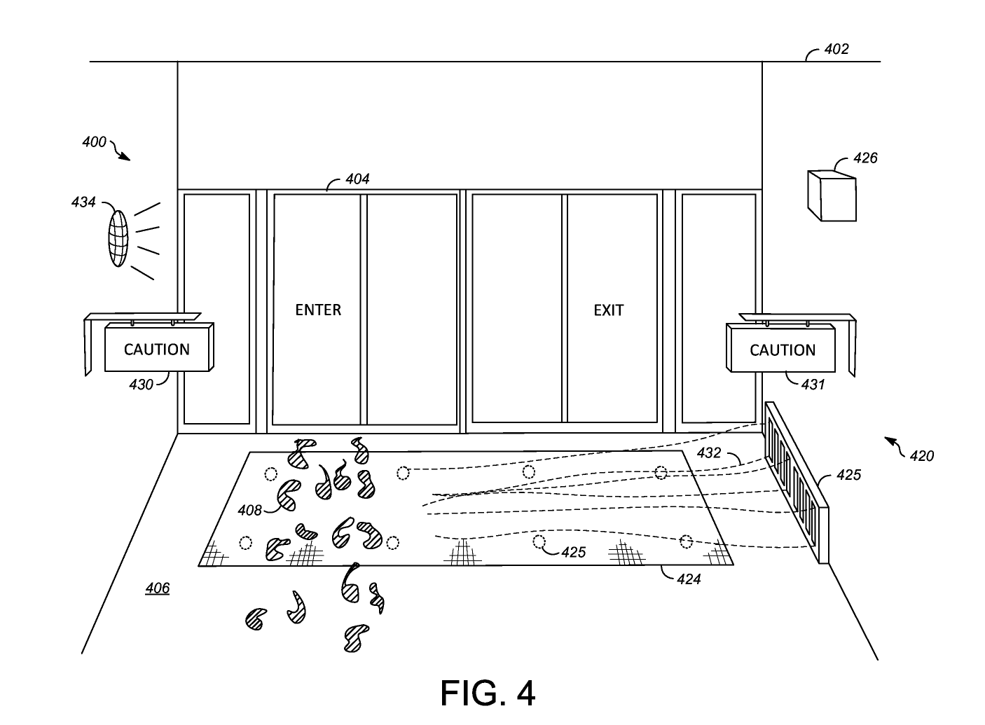

FIG. 4 shows a fourth example apparatus 400 in which a drying system 420 is installed in a building 402 having an entranceway 404 and a floor 406. Tracked water 408 can be detected by a rug or mat 424 on the floor 406 of the building 402 having one or more moisture sensors 425. The moisture sensors 412 may signal a controller 428 that moisture has been detected, whereupon the controller 428 may signal warning devices 430, 431, in this case “caution” signs mounted on the inner walls of the building 402 which flash or illuminate to indicate to pedestrians a potentially hazardous condition on the floor 406 of the building 402.

The controller 428 can also signal a built-in electric blower (not shown) to begin blowing rapidly moving air 432 across the floor 406 of the building 402 to dry the tracked water 408 on the rug or mat 424 on the floor 406 of the building 402. Again, the electric blower 422 may have a heating element (not shown) built therein so that the electric blower 422 may blow warm or hot air across the floor 406 of the building 402 in order to reduce the amount of time required to dry the mat 424 and/or the floor 406. When the moisture sensors 412 indicate that the mat 424 and/or floor 406 is sufficiently dry by signaling the controller 426, the controller 426 may signal the warning devices 430, 431 to stop indicating a hazardous condition exist and signal the built-in blower to stop blowing the rapidly moving air 432.

Audible warning devices 434 may be provided, and can include a recording of a person offering a verbal warning regarding a possible wet floor or a particular warning sound, such as a low-level siren. In addition, the previous examples may be modified by to include the audible warning devices 434 in addition to or in place of the warning devices, such as the warning lights and warning signs described above.

Aspects of the disclosed embodiments can include other techniques for drying floors in addition to or in place of fans or blowers, including forced heated air, automatic application of mechanical drying devices such as “squeegee” blades or infrared radiation. Aspects of the disclosed embodiments can activate the warning devices and drying devices on a timer circuit, wherein upon detection of a potential wet floor condition, the warning devices and the drying devices will operate for a predetermined amount of time. The timers could be tied in with the outdoor weather sensors such that the outdoor weather sensors could initiate the timers by providing a signal upon realizing wet conditions, or a user could manually engage the timer upon realizing wet weather conditions outdoors, such as rain, snow, and/or hail.

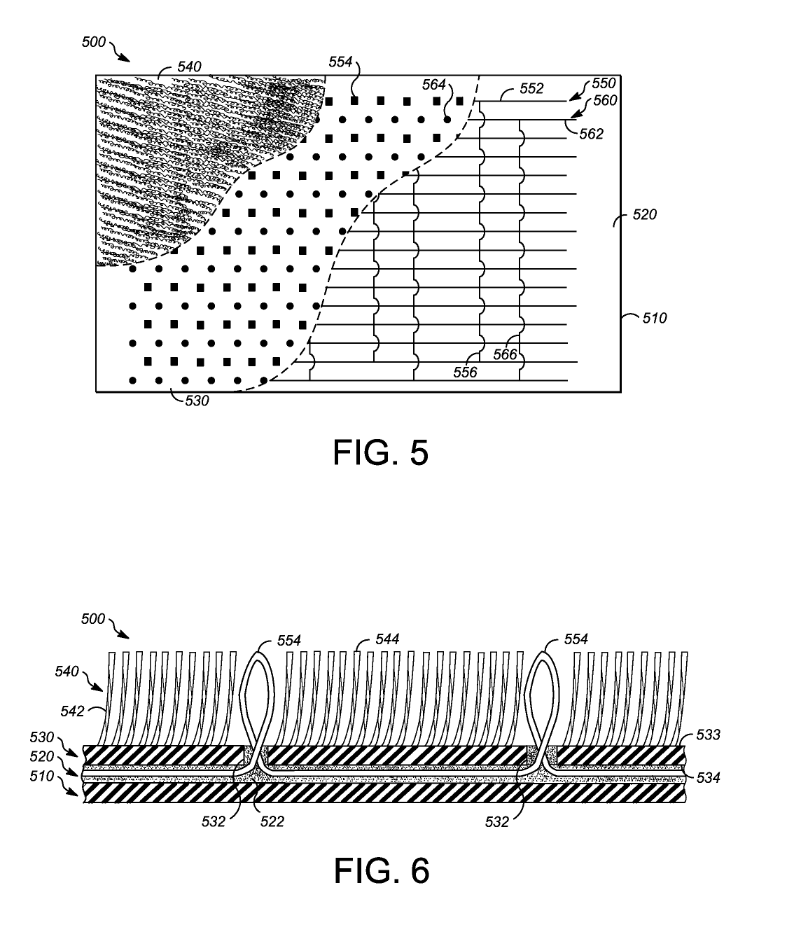

FIGS. 5-6 show moisture detecting floor mat 500. The moisture detecting floor mat 500 can be used as a moisture detector in the examples described in connection with FIGS. 1-4. For instance, the moisture detecting floor mat 500 can be utilized in place of the mat 424 of FIG. 4. The moisture detecting floor mat 500 includes a base layer 510, an intermediate layer 520, a carpet backing layer 530, and a carpet layer 540. The moisture detecting floor mat 500 also includes a first electrode assembly 550 and a second electrode assembly 560. The first electrode assembly 550 includes a first conductor portion 552 and a plurality of first electrodes 554 that are connected to the first conductor portion 552. The second electrode assembly 560 is similar to the first electrode assembly 550 and includes a second conductor portion 562 and a plurality of second electrodes 564.

The base layer 510 and the carpet backing layer 530 are each formed from an impermeable and non-conductive material. An example of a suitable material is rubber. Other materials can be utilized. The base layer 510 can be substantially continuous without interruptions, holes, or other discontinuities. The carpet backing layer 530 includes a plurality of apertures 532. Each of the electrodes from the plurality of first electrodes 554 and each of the electrodes from the plurality of second electrodes 564 extends through a respective one of the apertures 532 such that the electrodes 554, 564 extend through the carpet backing layer 530. Thus, the electrodes from the plurality of first electrodes 554 and the electrodes from the plurality of second electrodes 564 are disposed within the carpet layer 540 among a plurality of carpet fibers 542 thereof, and the electrodes 554, 564 can extend from the carpet backing layer 530 to a carpet surface 544 that is defined by the carpet fibers 542 of the carpet layer 540.

The carpet backing layer 530 can define a top surface 533 that faces the carpet layer 540 and a bottom surface 534 that faces the intermediate layer 520. Within the intermediate layer 520, the first conductor portion 552 of the first electrode assembly 550 and the second conductor portion 562 of the second electrode assembly 560 are disposed between the base layer 510 and the carpet backing layer 530. The first conductor portion 552 and the second conductor portion 562 are electrically isolated from one another such that the first electrode assembly 550 and the second electrode assembly 560 are electrically isolated from one another within the intermediate layer 520. This can be accomplished by providing insulating material between portions of the first electrode assembly 550 and the second electrode assembly 560 that might otherwise come in contact, such as at redundant connections 556, 566 between portions of the first electrode assembly 550 and the second electrode assembly 560.

The intermediate layer 520 can be an adhesive layer, with the first conductor portion 552 of the first electrode assembly 550 and the second conductor portion 562 of the second electrode assembly 560 being embedded within an adhesive 522 within the intermediate layer 520. The adhesive 522 can secure the carpet backing layer 530 to the base layer 510, secure the first electrode assembly 550 and the second electrode assembly 560 in place, and prevent intrusion of water into the intermediate layer 520. Thus, water is prevented from contacting the first conductor portion 552 of the first electrode assembly 550 and the second conductor portion 562 of the second electrode assembly 560.

As best seen in FIG. 5, the plurality of first electrodes 554 and the plurality of second electrodes 564 can be disposed within the carpet layer 540 and an overlapping pattern, such as overlapping grids. As will be explained further herein, the first electrode assembly 550 and the second electrode assembly 560 are utilized to presence of moisture in the carpet layer 540 by completion of an electrical circuit between the first electrode assembly 550 and the second electrode assembly 560 by way of a wetted area of the carpet layer that includes electrodes from each of the plurality of electrodes 554 and the plurality of second electrodes 564. Because the wetted portion of the carpet layer 540 will conduct electricity, completion of an electrical circuit that includes electrodes from the plurality of first electrodes 554, the plurality of second electrodes 564, and the wetted portion of the carpet signifies that the carpet layer 540 is moist, and thus completion of this electrical circuit can be used as a basis for outputting the moisture detection signal.

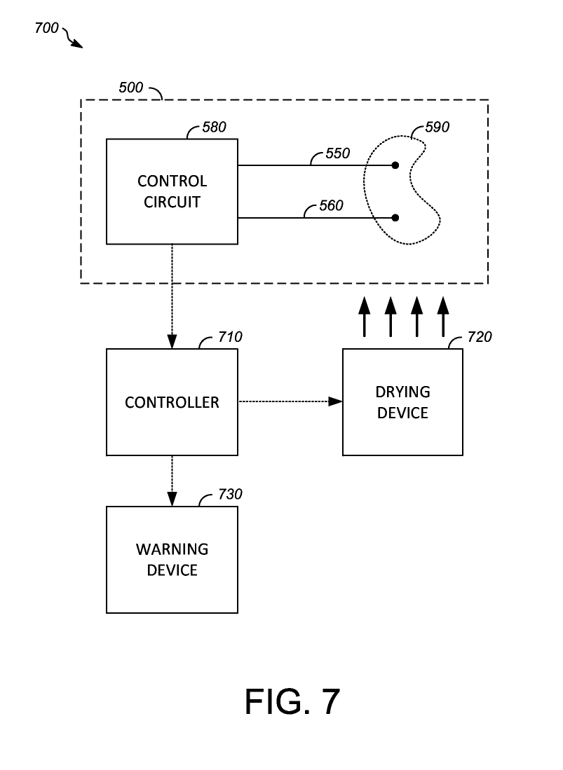

FIG. 7 is a block diagram showing a system 700 that includes the moisture detecting floor mat 500 of FIGS. 5-6. In the system 700, the moisture detecting floor mat 500 utilizes a control circuit 580 to generate the moisture detection signal when the first electrode assembly 550 and the second electrode assembly 560 complete an electrical signal via a wetted area 590 of the carpet layer 540. The control circuit 580 can include a transmitter that is operable to wirelessly transmit the moisture detection signal to a controller 710, which is similar to the controllers described in connection with the examples of FIGS. 1-4.

Based on the moisture detection signal, the controller 710 determines whether to perform one or more actions, for example, by comparing the moisture detection signal to a predetermined condition. The predetermined condition can be presence or absence of the moisture detection signal, a time with respect to which the moisture detection signal has been present or absent or any other desired condition. Upon determining that the condition is satisfied, the one or more actions taken by the controller 710 can include transmitting an operating signal to a drying device 720, which is similar to the drying device described in connection with the examples of FIGS. 1-4. The operating signal can be transmitted from the controller to the drying device by either a wired electrical transmission or a wireless electrical transmission. The one or more actions that can be taken by the controller 710 also include transmitting a warning condition signal to a warning device 730, which is similar to the warning device as described in connection with the examples of FIGS. 1-4. The warning condition signal can be transmitted by wired or wireless electrical communication from the controller 710 to the warning device 730.

From the foregoing examples, it will be appreciate that the apparatuses described with connection to FIGS. 1-7 can be utilized in a method for automatically drying wet floors that includes detecting the presence of moisture by a moisture detector at a first location and transmitting a moisture detection signal from the moisture detector to a controller in response to detecting the presence of moisture at the first location. Such a method can also include outputting an operating signal from the controller to a blower based on the moisture detection signal if an operating condition is satisfied. The method that includes operating the blower in response to the operating signal. Such a method can also include outputting a warning condition signal from the controller to a warning device based on the moisture detection signal if an operating condition is satisfied and operating the warning device in response to the warning condition signal. Such a method can also include detecting the moisture using a moisture detector as described in connection with the examples of FIGS. 1-7, such as the video camera 128 of FIG. 1, the wet weather sensor 110 of FIG. 1, the mat 222 of FIG. 2, the mats 322, 323 of FIG. 3, the mat 424 of FIG. 4, and the moisture detecting floor mat 500 of FIGS. 5-7.

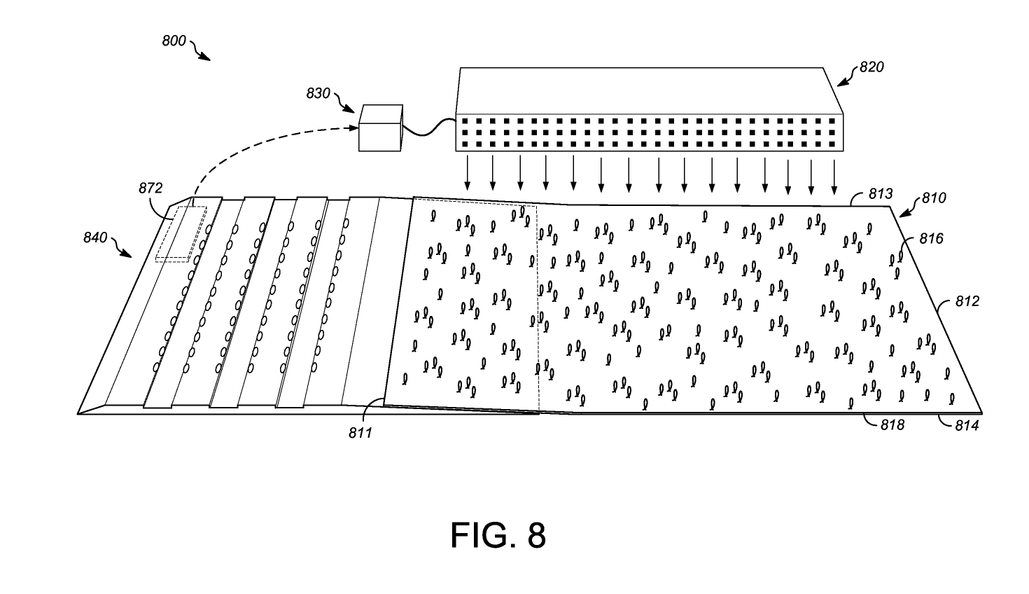

FIG. 8 shows a fifth example apparatus 800 for drying wet floors. The fifth example apparatus 800 can be installed in an entranceway of a building, adjacent to a door that leads to the exterior of the building, as noted with respect to previous examples. The fifth example apparatus 800 includes a floor mat 810, a floor dryer 820, a controller 830, and a detector mat 840. The detector mat 840 is positioned adjacent to the floor mat 810 so that the moisture conditions at the detector mat 840 will be similar to the moisture conditions at the floor mat 810. In the illustrated example, the floor mat 810 is positioned such that it overlies a portion of the detector mat 840.

The floor mat 810 is a removable floor covering that is positioned in an entryway to remove moisture and dirt from the shoes of persons entering the building, and can be easily removed for cleaning. The floor mat 810 extends in a lengthwise direction from a first end 811 to a second end 812 and extends in a widthwise direction from a first side 813 to a second side 814. The floor mat 810 includes an absorbent layer that retains moisture, such as a carpet layer 816. In the illustrated example, the floor mat also includes a backing layer 818 that supports the carpet layer 816. The backing layer 818 can be a layer of thin, flexible, liquid impervious, and electrically non-conductive material, such as synthetic rubber. In this implementation, the floor mat 810 does not include any electronic components, such as moisture detecting electrodes.

The floor dryer 820 can be an electric blower, as described previously, and is placed adjacent to the floor mat 810 to dry the floor mat 810 by directing moving air toward the floor mat 810. The controller 830 is operable to start and end operation of the floor dryer 820, such as by a relay, in response to a moisture detection signal that is received by the controller 830 from the detector mat 840 by a wired connection or a wireless connection in the same manner described in connection with the previously-described systems. The controller 830 can also cause operation of a visible or audible warning device as previously described.

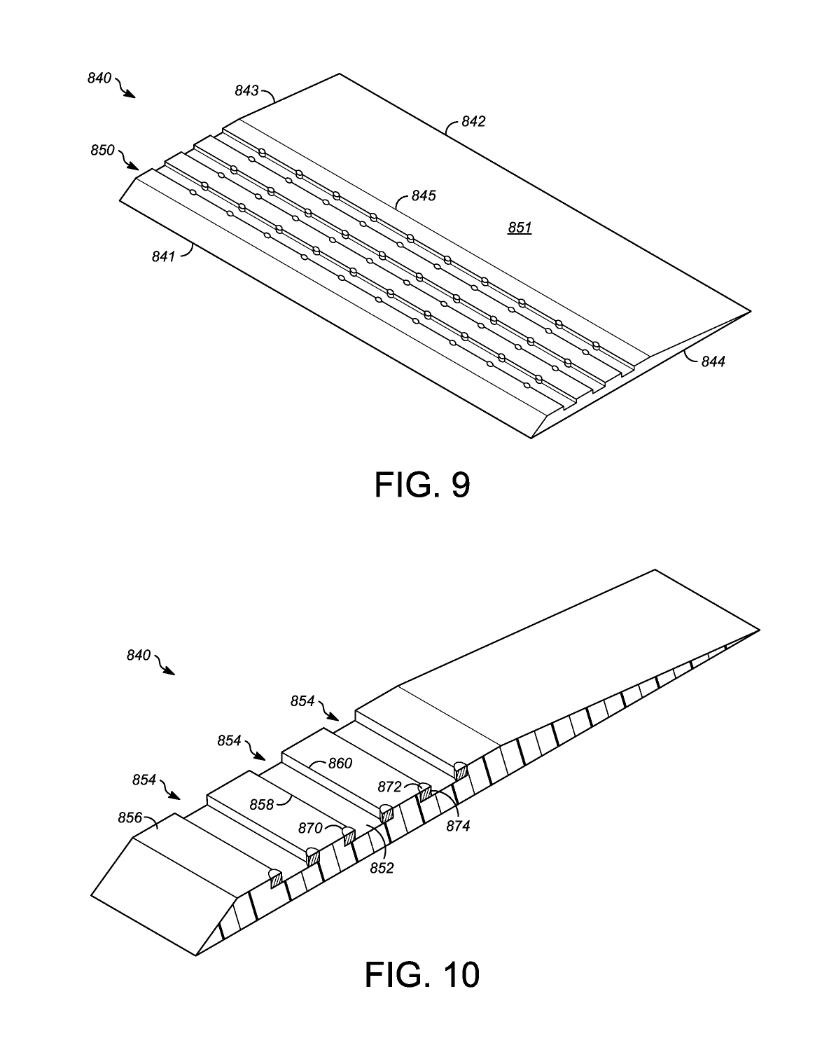

FIGS. 9-10 show the detector mat 840. The detector mat 840 extends in a lengthwise direction from a first end 841 to a second end 842 and extends in a widthwise direction from a first side 843 to a second side 844.

The detector mat 840 is formed primarily of a material that is liquid impervious, and electrically non-conductive material, such as synthetic rubber or other high-friction material that provides good traction when wet. The detector mat 840 includes a first portion 850 and a second portion 851. The first portion 850 extends from the first end 841 to an intermediate point 845. The second portion 851 extends from the intermediate point 845 to the second end 842. In some implementations, the first portion 850 has a substantially constant thickness while the second portion 851 is thinner than the first portion or is tapered with respect to the first portion 850. This allows the detector mat 840 to be closely positioned with respect to the floor mat 810 by placing the second portion 851 of the detector mat under the floor mat 810, such as with the first end 811 of the floor mat 810 being positioned near the intermediate point 845.

The first portion 850 of the detector mat 840 includes a top surface 852 and a plurality of channels 854. The top surface 852 is positioned at a first elevation, with the channels 854 being recessed with respect to the top surface 852. Each of the channels 854 includes a bottom surface 856 that is disposed at a second elevation that is lower than the first elevation, with the first and second elevations being measured as a distance from a bottom surface of the detector mat 840. The channels 854 also have a first side surface 858 and a second side surface 860. The first side surface 858 and the second side surface 860 each extend upward from the bottom surface 856 to the top surface 852. The second portion 851 of the detector mat 840 can be free from channels, as in the illustrated example.

A plurality of sensing electrodes 870 are positioned along the channels 854 of the first portion 850 of the detector mat 840. The second portion 851 of the detector mat 840 can be free of sensing electrodes. Each of the sensing electrodes 870 is paired with at least one other electrode such that moisture can be detected when sufficient moisture is present on the detector mat 840 or on an object touching the detector mat 840 (e.g. the sole of a person's shoe) to allow electricity to be conducted via the moisture and complete a circuit between the electrodes. This can be done, for example, by splitting the sensing electrodes 870 into two groups, as explained with respect to the plurality of first electrodes 554 and the plurality of second electrodes 564 of FIG. 5. The sensing electrodes 870 are interconnected and are also connected to a control circuit 872 by electrical conductors (not shown) that are embedded within the body of the detector mat. The control circuit 872 can be incorporated in the detector mat 840, such as being embedded in the body of the detector mat 840. The control circuit 872 generates a moisture detection signal and transmits it to the controller 830, by a wired or wireless connection, such as by a transmitter that is operable to wirelessly transmit the moisture detection signal to a controller 830.

Each of the sensing electrodes 870 is positioned along one of the channels 854. A portion of each electrode extends through, is embedded in, interrupts, or is otherwise exposed to the first side surface 858 or the second side surface 860. For example, each of the sensing electrodes 870 can be positioned on one of the first side surface 858 or the second side surface 860 and extend from the bottom surface 856 to the top surface 852. Thus, if water collects in one of the channels 854, the water can come into contact with a pair of the sensing electrodes 870 and thereby complete a circuit between the pair of the sensing electrodes, where completion of this circuit constitutes an electrical signal that is received by the control circuit 872 and interpreted as indicating that moisture is present on the detector mat 840. A portion of each electrode can extend through, be embedded in, interrupt, or otherwise be exposed to the top surface 852. Thus, water lying on the top surface 852 can complete a circuit between the pair of the sensing electrodes, or a wetted object that engages the top surface 852 can complete a circuit between the pair of the sensing electrodes and output the electrical signal to the control circuit 872. In one implementation, each of the sensing electrodes 870 can include a first portion 874 that is positioned along one of the first side surface 858 or the second side surface 860 of one of the channels 854 and a second portion 876 that is positioned along the top surface 852. For example, the sensing electrodes could be or include a rectangular metal body, a cylindrical metal body, an L-shaped metal body, or a metal body or member or any configuration that results in a first portion or surface being positioned along one of the channels 854 and a second portion or surface being positioned along the top surface 852.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An apparatus for automatically drying wet floors, comprising:
a floor mat;
a controller;
a detector mat that is positioned adjacent to the floor mat, the detector mat having at least one moisture sensing element that is operable to detect moisture and transmit a moisture detection signal to the controller in response to detecting the presence of moisture at the first location; and
a floor dryer that is operative to turn on and off for drying the floor mat by directing moving air toward the floor mat in response to an operating signal from the controller, wherein the controller outputs the operating signal to the blower based on the moisture detection signal.

2. The apparatus of claim 1, wherein the detector mat includes a body and the at least one moisture sensing element includes a plurality of electrodes that are disposed on the body.

3. The apparatus of claim 2, wherein the body of the detector mat is liquid impervious.

4. The apparatus of claim 2, wherein the body of the detector mat includes a plurality of channels that are recessed with respect to a top surface of the detector mat.

5. The apparatus of claim 4, wherein at least some of the electrodes are positioned along the channels.

6. The apparatus of claim 5, wherein at least some of the electrodes have a first portion positioned on a wall of one of the channels and a second portion positioned on the top surface of the detector mat.

7. The apparatus of claim 4, wherein the channels are formed in a first portion of the detector mat and the floor mat is positioned such that it overlies a second portion of the detector mat.

8. The apparatus of claim 7, wherein the floor mat includes a backing layer and a carpet layer that is disposed on the backing layer.

9. The apparatus of claim 7, wherein the first portion of the detector mat is thicker than the second portion of the detector mat.

10. The apparatus of claim 7, wherein the second portion of the detector mat is tapered with respect to the first portion of the detector mat.

11. An apparatus for automatically drying wet floors, comprising:
a floor mat having a backing layer and a carpet layer that is disposed on the backing layer;
a controller;
a detector mat that is positioned adjacent to the floor mat, the detector mat having at least one moisture sensing element that is operable to detect moisture and transmit a moisture detection signal to the controller in response to detecting the presence of moisture at the first location, wherein the detector mat includes a body that is liquid impervious, the at least one moisture sensing element includes a plurality of electrodes that are disposed on the body, the body of the detector mat includes a plurality of channels that are recessed with respect to a top surface of the detector mat, and at least some of the electrodes are positioned along the channels; and
a floor dryer that is operative to turn on and off for drying the floor mat by directing moving air toward the floor mat in response to an operating signal from the controller, wherein the controller outputs the operating signal to the blower based on the moisture detection signal.

12. The apparatus of claim 11, wherein at least some of the electrodes have a first portion positioned on a wall of one of the channels and a second portion positioned on the top surface of the detector mat.

13. The apparatus of claim 11, wherein the channels are formed in a first portion of the detector mat and the floor mat is positioned such that it overlies a second portion of the detector mat.

14. The apparatus of claim 13, wherein the first portion of the detector mat is thicker than the second portion of the detector mat.

15. The apparatus of claim 13, wherein the second portion of the detector mat is tapered with respect to the first portion of the detector mat.

16. A detector mat for detecting moisture, comprising:
a body that is liquid impervious and includes a plurality of channels that are recessed with respect to a top surface of the body; and
at least one moisture sensing element that is operable to detect moisture and output a moisture detection signal in response to detecting the presence of moisture at the first location, wherein the at least one moisture sensing element includes a plurality of electrodes that are disposed on the body and at least some of the electrodes are positioned along the channels of the body.

17. The detector mat of claim 16, wherein at least some of the electrodes have a first portion positioned on a wall of one of the channels and a second portion positioned on the top surface of the detector mat.

18. The detector mat of claim 16, wherein the channels are formed in a first portion of the detector mat and a second portion of the detector mat is free of channels.

19. The detector mat of claim 18, wherein the first portion of the detector mat is thicker than the second portion of the detector mat.

20. The detector mat of claim 18, wherein the second portion of the detector mat is tapered with respect to the first portion of the detector mat.
